(19) United States
(12) Patent Application Publication
(10) Pub. No.: US 2017/0278479 A1
(43) Pub. Date: Sep. 28, 2017

(54) DISPLAY DEVICE, DISPLAY METHOD, AND NON-TRANSITORY STORAGE MEDIUM

(71) Applicant: JVC KENWOOD Corporation, Yokohama-shi (JP)

(72) Inventor: Tatsushi Nakanishi, Yokohama-shi (JP)

(21) Appl. No.: 15/371,603

(22) Filed: Dec. 7, 2016

(30) Foreign Application Priority Data
Mar. 24, 2016 (JP) 2016-060624

(51) Int. Cl. G09G 5/00; G06F 3/0488; G06F 17/30; G09G 5/377

(52) U.S. Cl. CPC G09G 5/006; G09G 5/377; G06F 3/0488; G06F 17/30781; G06F 17/30312; G09G 2340/125; G06F 3/0416

(57) ABSTRACT

A display device comprises a display configured to be capable of displaying information including video, an input unit configured to be capable of outputting a first command signal when a first operation is performed and outputting a second command signal when a second operation is performed, a storage configured to store video data of a game of baseball captured in advance and scorebook data for the game, and a controller configured to, when the first command signal is output, display game video of the game on the display based on the video data, and, when the second command signal is output, extract a hitting result in at least at-bat of a batter displayed on the display from the scorebook data and display the game video of the game on the display while superimposing result information including the hitting result on the game video.

### CROSS-REFERENCE TO RELATED APPLICATION

The present application claims priority to and incorporates by reference the entire contents of Japanese Patent Application No. 2016-060624 filed in Japan on Mar. 24, 2016.

### FIELD

The present disclosure relates to a display device, a display method, and a non-transitory storage medium which stores a display program.

### BACKGROUND

Display technologies enabling users to watch a game while viewing score information by displaying score information of a scorebook together on game video of a baseball game are known (for example, see JP 2005-236541 A).

In a display technology described in JP 2005-236541 A, score information corresponding to an event displayed on a display or the like is displayed. For example, for an event of a batter's swing for a pitch of a pitcher, score information of a swing is displayed. In addition, for example, for an event of a batter's hit for a pitcher's pitch to be a single hit, score information of the single hit is displayed.

However, in the display technology described in JP 2005-236541 A, only score information corresponding to a displayed event is displayed. Thus, for example, when score information of a batter's hitting result at-bat or a runners' base running result at-bat is desired to be known, a user needs to wait until a corresponding event is displayed. Accordingly, it is requested to more effectively display score information of a scorebook instead of only displaying an event displayed in a display or the like and score information of the event in association with each other.

### SUMMARY

It is an object of the present disclosure to at least partially solve the problems in the conventional technology.

According to one embodiment of the present disclosure, there is provided a display device comprising a display configured to be capable of displaying information including video, an input unit configured to be capable of outputting a first command signal when a first operation is performed and outputting a second command signal when a second operation is performed, a storage configured to store video data of a game of baseball captured in advance and scorebook data for the game, and a controller configured to, when the first command signal is output, display game video of the game on the display based on the video data, and, when the second command signal is output, extract a hitting result in at least at-bat of a batter displayed on the display from the scorebook data and display the game video of the game on the display while superimposing result information including the hitting result on the game video.

According to one embodiment of the present disclosure, there is provided a display method for displaying information in a display device including a display configured to be capable of displaying information including video, an input unit configured to be capable of outputting a first command signal when a first operation is performed and outputting a second command signal when a second operation is performed, and a storage configured to store video data of a game of baseball captured in advance and scorebook data for the game, the display method comprising displaying game video of the game on the display based on the video data when the first command signal is output, and extracting a hitting result in at least at-bat of a batter displayed on the display from the scorebook data and displaying the game video of the game on the display while superimposing result information including the hitting result on the game video when the second command signal is output.

According to one embodiment of the present disclosure, there is provided a non-transitory storage medium that stores a display program for displaying information in a display device including a display configured to be capable of displaying information including video, an input unit configured to be capable of outputting a first command signal when a first operation is performed and outputting a second command signal when a second operation is performed, and a storage configured to store video data of a game of baseball captured in advance and scorebook data for the game, the display program causing the display device to perform processes of displaying game video of the game on the display based on the video data when the first command signal is output, and extracting a hitting result in at least at-bat of a batter displayed on the display from the scorebook data and displaying the game video of the game on the display while superimposing result information including the hitting result on the game video when the second command signal is output.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram that illustrates an example of a display device according to this embodiment;

FIG. 2 is a diagram that illustrates an example of a display device according to this embodiment;

FIG. 3 is a diagram that illustrates an example of scorebook data stored in a scorebook data storage unit;

FIG. 4 is a diagram that illustrates an example of synchronization information stored in a synchronization information storage unit;

FIG. 5 is a block diagram that illustrates an example of a controller;

FIG. 6 is a flowchart that illustrates an example of the operation of the display device according to this embodiment;

FIG. 7 is a diagram that illustrates a display content of a display of a display device;

FIG. 8 is a diagram that illustrates a display content of a display of a display device;

FIG. 9 is a diagram that illustrates a display content of a display of a display device;

FIG. 10 is a diagram that illustrates a display content of a display of a display device according to a second embodiment;

FIG. 11 is a block diagram that illustrates an example of a controller of a display device according to a second embodiment;

FIG. 12 is a flowchart that illustrates an example of the operation of the display device according to this embodiment;

FIG. 13 is a diagram that illustrates a display content of a display of a display device;

FIG. 14 is a diagram that illustrates a display content of a display of a display device;

FIG. 15 is a flowchart that illustrates another example of the operation of the display device according to this embodiment; and

FIG. 16 is a block diagram that illustrates another example of a controller of the display device according to the second embodiment.

### DETAILED DESCRIPTION OF THE PREFERRED EMBODIMENTS

Hereinafter, a display device, a display method, and a non-transitory storage medium which stores a display program according to embodiments of the present disclosure will be described with reference to the drawings. However, the present disclosure is not limited to such embodiments. In the embodiments described below, a constituent element includes an element with which the constituent element can be easily replaced by a person skilled in the art or an element that is substantially the same as the constituent element.

### First Embodiment

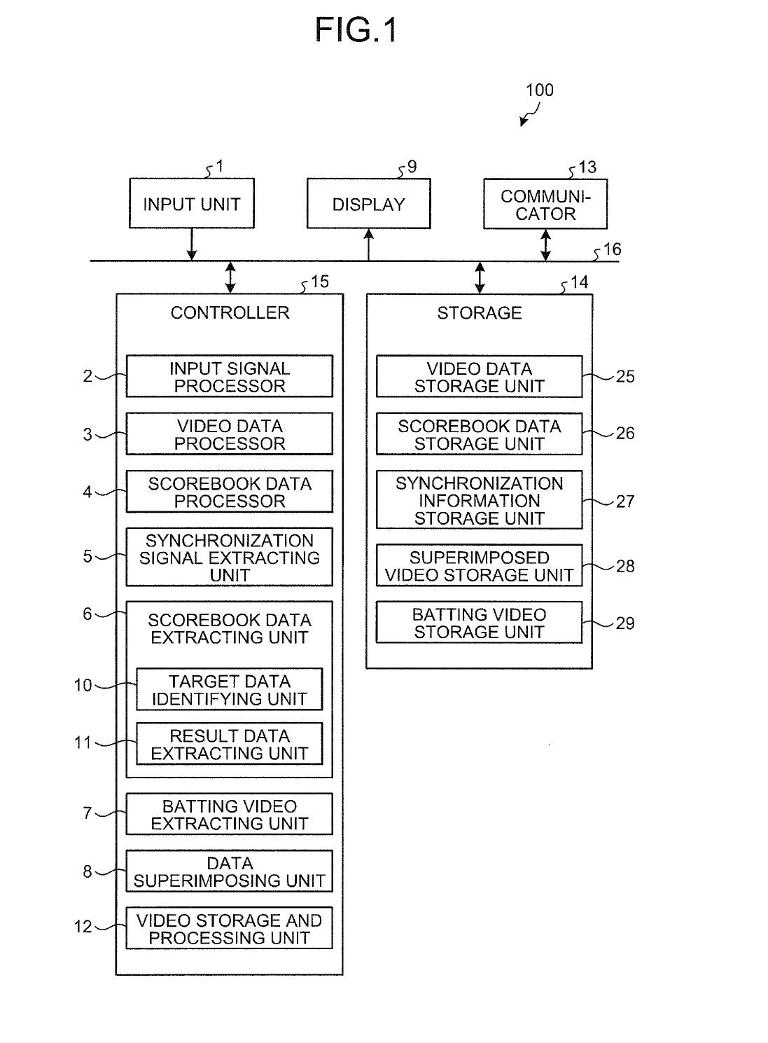

FIG. 1 is a block diagram that illustrates an example of a display device 100 according to this embodiment. The display device 100 illustrated in FIG. 1, for example, displays game video of a baseball game based on video data of the baseball game captured in advance. As illustrated in FIG. 1, the display device 100 includes an input unit 1, a display 9, a communicator 13, a storage 14, and a controller 15. The input unit 1, the display 9, the communicator 13, the storage 14, and the controller 15 are interconnected, for example, through a bus line 16.

The input unit 1 outputs an command signal to the controller 15. As the input unit 1, for example, an input device such as a touch panel is used. As the input unit 1, in addition to or instead of the touch panel, a button, a lever, a dial, a switch, or any other input device may be used. The input unit 1 outputs a command signal according to a predetermined input operation. The display 9 displays various kinds of information including texts and images. The display 9 includes a display panel such as a liquid crystal panel. The display 9 can display information including video.

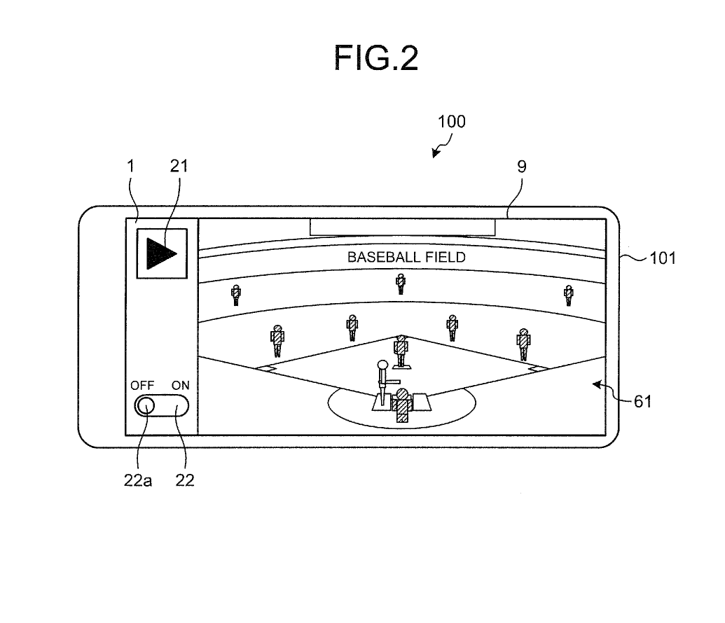

FIG. 2 is a diagram that illustrates an example of the display device 100 according to this embodiment. As illustrated in FIG. 2, the display device 100, for example, includes a casing 101 of a portable terminal type. An input unit 1 and a display 9 are disposed on the front face of the casing 101. In addition, a communicator 13, a storage 14, and a controller 15 are disposed inside the casing 101.

As illustrated in FIG. 2, a touch panel as the input unit 1 is arranged to be superimposed on a display 9. The display 9 can display an operation image. On the display 9, as the operation image, for example, a button 21 and a switch 22 are displayed. The button 21 and the switch 22 are displayed in mutually-different areas of the display 9.

When a touch operation is performed for an area of the touch panel that is superimposed on the button 21 or the switch 22 that is an operation image, the input unit 1 outputs predetermined command signals. For example, when a touch operation is performed for a portion superimposed on the button 21 as a first operation, the input unit 1 outputs a first command signal. When the first command signal is being output, the display 9 may display the button 21 with black/white inverted. In such a case, it can be easily checked whether or not the first command signal is being output.

On the other hand, when a touch operation is performed for a portion superimposed on the switch 22 as a second operation, the input unit 1 outputs a second command signal or a third command signal. When the input unit 1 outputs the second command signal, the display 9 displays a circular part 22a to the position of “ON”. On the other hand, when the third command signal is output, the display 9 displays the circular part 22a at the position of “OFF”. In this case, a state can be easily checked in which whether the second command signal or the third command signal is being output. The first command signal, the second command signal, and the third command signal will be described later. Here, the configuration of the input unit 1 and the display 9 is not limited to the configuration described above.

As illustrated in FIG. 1, the communicator 13 communicates for information with an external device in a wired manner or a wireless manner. The communicator 13, for example, transmits/receives video data and the like to/from an external imaging device. The display device 100 may be configured to include an imaging device.

The storage 14, for example, includes a storage such as a hard disk drive or a solid state drive. As the storage 14, an external storage medium such as a removable disk may be used. The storage 14 stores an operating system of the display device 100, various programs and data used for controlling the operations of the input unit 1, the display 9, and the communicator 13, and the like.

In addition, the storage 14 stores a display program which causes the display device 100 to perform display, to perform a process of displaying game video of a game on the display 9 based on video data of a baseball game captured in advance when the first command signal is output, and to perform a process of extracting at least a hitting result of a batter at the bat who is displayed on the display 9 from scorebook data for games and a process of displaying result information including the hitting result on the display 9 with being superimposed with the game video when the second command signal is output.

The storage 14 includes a video data storage unit 25, a scorebook data storage unit 26, a synchronization information storage unit 27, an superimposed video storage unit 28, and a batting video storage unit 29.

The video data storage unit 25 stores video data. The video data includes data of game video captured in advance for baseball games. The video data is associated with time data. The time data, for example, may be time of capturing of the game video or elapsed time from the start of capturing of the game video. The video data storage unit 25 can store a plurality of pieces of video data.

The scorebook data storage unit 26 stores scorebook data of games corresponding to video data stored in the video data storage unit 25. The scorebook data includes data of scores written in a baseball scorebook. The scores recorded in the scorebook will be briefly described. The scores are aggregations of score information. The score information is an individual event which occurs due to each pitch of a pitcher. Thus, a plurality of pieces of score information is generated for one pitch of a pitcher, and one score is generated using the plurality of pieces of the score information. For example, when a hitting result is fly out to right and a runner on first base is also tagged out, score information that the batter is out, score information about fly out to right, and score information that the first-base runner was tagged out are generated, and one score is configured by such score information.

Besides the score information above, the score may include an action of a batter, an action of a fielder, determination of a count, state of advancement of a runner when there is already a runner on base, other play of batters and fielders, and the like. Specifically, the score may include score information such as a strike, a ball, a foul, hitting result, type of a batted ball, a catching fielder, advancement result, and the like. The hitting result is information of “out”, a single hit, a two-base hit, a three-base hit, a homerun, and the like. The type of a batted ball is information such as a ground ball, a line drive, a fly, a bunt, and the like, but may be categorized into more types. A catching fielder is information for identifying a fielder who has actually caught the ball or the position of the fielder. The advancement result is information about advancement of a runner on base, such as “from first base to second base”, but other play and the like of batters and fielders may also be included.

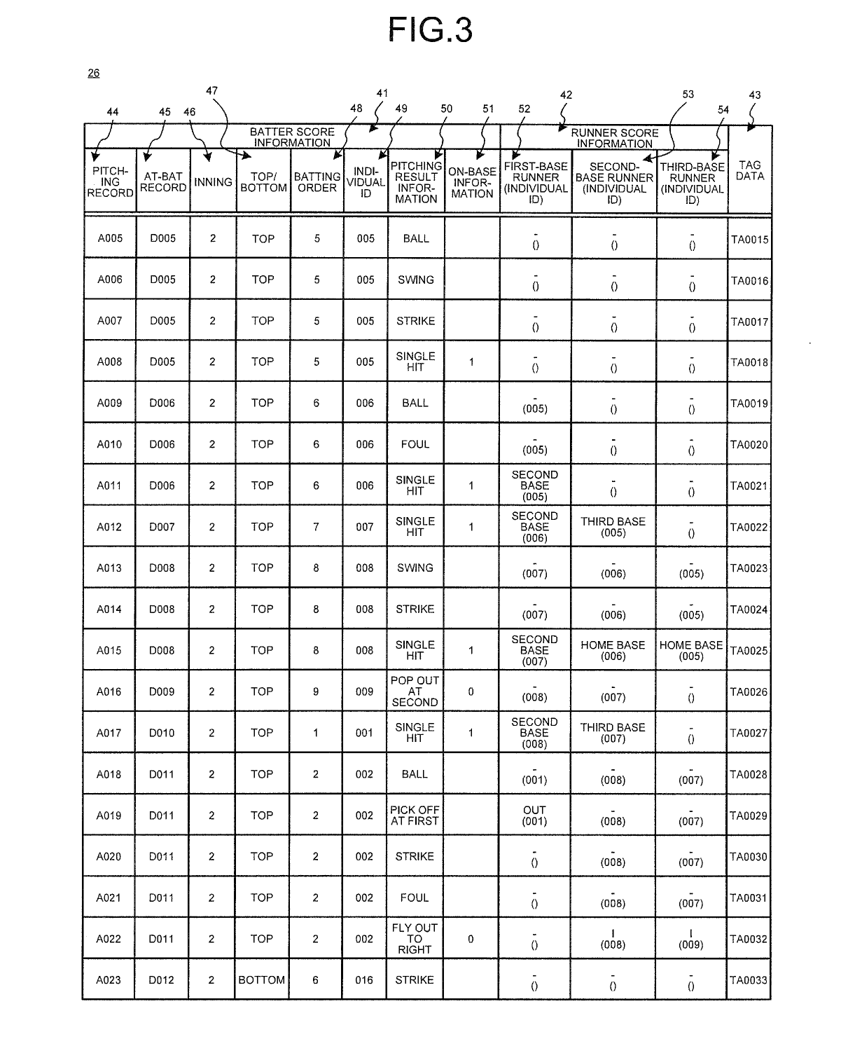

FIG. 3 is a diagram that illustrates an example of scorebook data stored in the scorebook data storage unit 26. In the example illustrated in FIG. 3, all the score information of top of the second inning and one piece of score information of bottom of the second inning are illustrated. As illustrated in FIG. 3, the scorebook data includes batter score information 41, runner score information 42, and tag data 43. The batter score information 41 includes pitching record 44, at-bat record 45, inning information 46, top/bottom information 47, batting order information 48, personal ID 49, pitching result information 50, and on-base information 51.

One pitching record 44 is created every time a pitcher throws a ball. As an index, a pitching record number is assigned to the pitching record 44 in the ascending order of the pitching. One at-bat record 75 is created every time one at-bat ends, that is, every time a score is determined. One or a plurality of pitching records is included in one at-bat record. In the at-bat record 45, an at-bat record number is assigned, as an index, to one at-bat in the ascending order.

The inning information 46 is information representing an inning number at which the pitching record 44 and the at-bat record 45 are generated. The top/bottom information 47 is information representing top or bottom of the inning. The batting order information 48 is information representing the batting order in one score and is represented as one of integers of “1” to “9”. The individual ID 49 is information identifying a batter in one score. The individual ID 49 is associated with information of a name of a corresponding batter by using a table or the like, not illustrated.

The pitching result information 50 is information representing a result for one pitching record 44. The pitching result information for the last pitch in one at-bat corresponds to a hitting result in the at-bat. In other words, a hitting result of a certain batter for one at-bat corresponds to pitching result information for the last pitch in said at-bat.

For example, as illustrated in FIG. 3, in scores of a batter (individual ID: 005) having an at-bat record number of D005, four pieces of information corresponding to four pitching record numbers A005 to A008 are included. Among these, pitching result information for the first pitch A0005 is a ball. Pitching result information for the second pitch A0006 is a swing. Pitching result information for the third pitch A0007 is a strike. Pitching result information for the fourth pitch A0008 is a single hit. In this case, a hitting result of the batter 005 in at-bat record D005 is a single hit.

The on-base information 51 is information representing an on-base status in at-bat record 45. The on-base information 51, for example, is represented as “0” or “1”. When the on-base information 51 is “0”, it represents a status in which a corresponding batter is out and is not on base. On the other hand, when the on-base information 51 is “1”, it represents a status in which a corresponding batter is on base in accordance with a hit, base on balls, or the like.

The batter score information 41 corresponds to score information of a batter's action, a fielder's action, determination of a count, or other play of a batter or a fielder, and the like in the score information described above. Here, the score information of other play and the like represents irregular events which should be preferably recorded separately from regular scores, such as an interference, an uncaught third strike, a balk, or the like.

The runner score information 42 is score information relating to an advancement result among the score information described above. The runner score information 42 includes first-base runner information 52, second-base runner information 53, and third-base runner information 54. The first-base runner information 52, the second-base runner information 53, and the third-base runner information 54 are generated for each pitching record 44. As illustrated in FIG. 3, each of the first-base runner information 52, the second-base runner information 53, and the third-base runner information 54, as illustrated on the upper side of each section, includes information representing a base up to which the runner advances for a corresponding pitching record. Each of the first-base runner information 52, the second-base runner information 53, and the third-base runner information 54, as illustrated on the lower side of each section, includes an individual ID for identifying a runner of the corresponding base.

For example, in a pitch of the pitching record number A011, it is represented that a batter of an individual ID 006 has a single hit in the at-bat of the at-bat record number D006, and the first-base runner of an individual ID 005 advances to second base.

For example, when a runner is out in accordance with a pick-off throw as in the pitching record A019, “out” is displayed on the upper side of each section of the first-base runner information 52, the second-base runner information 53, and the third-base runner information 54, and an individual ID of the runner who is out is displayed on the lower side of each section. In addition, also in the case of force-out or tag-out, a similar display is made.

The tag data 43 is information for identifying score information generated for each pitching record 44. One piece of tag data 43 is generated every time when the pitching record 44 is generated. Tag numbers (TA0015, TA0016, . . . ) are assigned to the tag data 43 in the ascending order as indices. The pitching record number of the pitching record 44 may be used as the tag data.

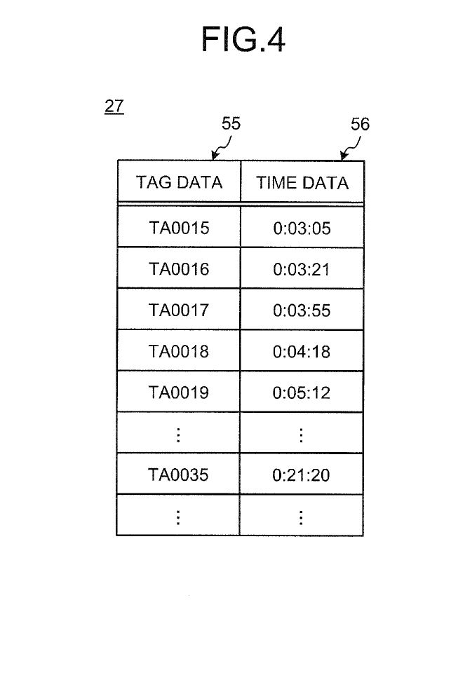

The synchronization information storage unit 27 stores synchronization information. FIG. 4 is a diagram that illustrates an example of the synchronization information stored in the synchronization information storage unit 27. As illustrated in FIG. 4, the synchronization information is information for associating video data and scorebook data with each other. The synchronization information includes tag data 55 and time data 56. The tag data 55 is information corresponding to the tag data 43 stored in the scorebook data storage unit 26. Tag numbers (TA0015, TA0016, . . . ) are assigned to the tag data 55 in the ascending order as indices for tags. In the tag data 43 and the tag data 55, for example, tags to which a same tag number is assigned are associated with each other. The time data 56 is information corresponding to time of video data stored in the video data storage unit 25. Based on the tag data 55 and the time data 56 that are the synchronization information, the score information of one pitch included in the scorebook data and the time of the game video included in the video data are associated with each other.

The superimposed video storage unit 28 stores superimposed data output from a data superimposing unit 8 to be described later. The batting video storage unit 29 stores video data output from a data superimposing unit 8 to be described later.

The controller 15 illustrated in FIG. 1 controls each unit of the input unit 1, the display 9, and the communicator 13. In addition, the controller 15 performs calculation, a process, or the like according to command signals from the input unit 1. The controller 15 includes: an input signal processor 2, a video data processor 3, a scorebook data processor 4, a synchronization signal extracting unit 5, a scorebook data extracting unit 6, a batting video extracting unit 7; a data superimposing unit 8, and a video storage and processing unit 12.

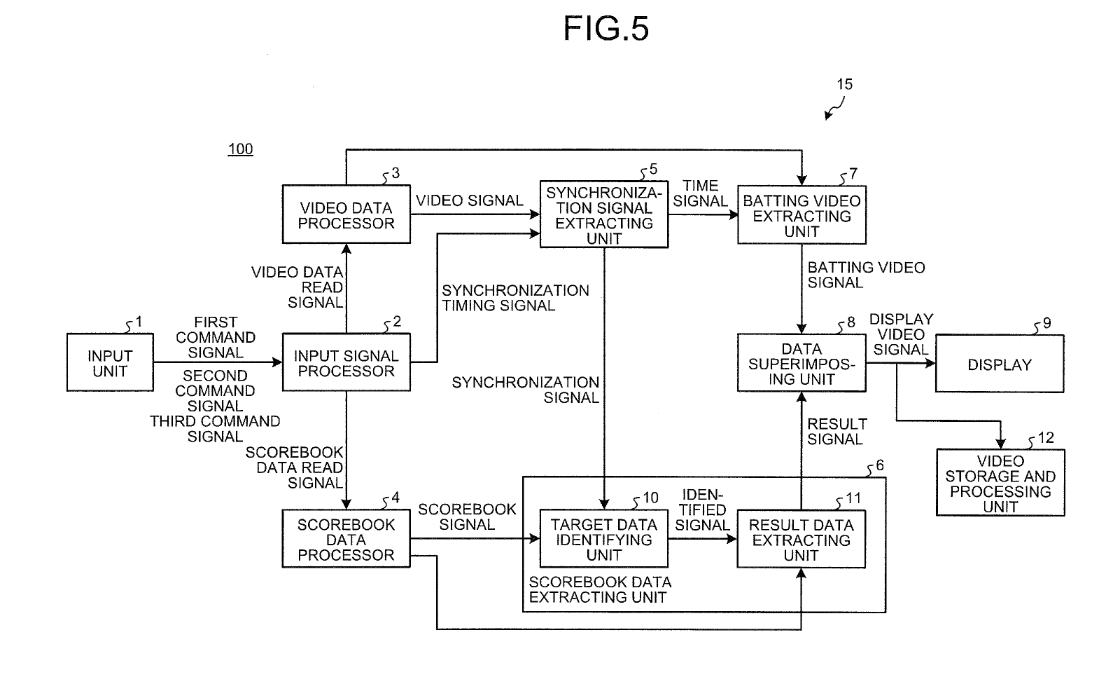

FIG. 5 is a block diagram that illustrates an example of the controller 15. FIG. 5 illustrates flow of signals in each unit of the controller 15. As illustrated in FIG. 5, a first command signal, a second command signal, and a third command signal output from the input unit 1 are input to the input signal processor 2. When the first command signal is input, the input signal processor 2 outputs a video data read signal to the video data processor 3. The video data read signal is a control signal for performing control of the video data processor 3 to read the video data stored in the video data storage unit 25. When the second command signal is input, the input signal processor 2 outputs a scorebook data read signal to the scorebook data processor 4 and also outputs a synchronization timing signal to the synchronization signal extracting unit 5. The scorebook data read signal is a control signal for performing control of the scorebook data processor 4 to read the scorebook data stored in the scorebook data storage unit 26. The synchronization timing signal is a control signal for performing control of the synchronization signal extracting unit 5 to read the synchronization information stored in the synchronization information storage unit 27. In addition, when the third command signal is input, the input signal processor 2 outputs a stop signal to the scorebook data processor 4 and the synchronization signal extracting unit 5. The stop signal is a control signal for stopping the reading of the scorebook data and the reading of the synchronization information.

The video data read signal is input to the video data processor 3. When the video data read signal is input, the video data processor 3 reads video data stored in the video data storage unit 25 and outputs a video signal to the synchronization signal extracting unit 5 and the batting video extracting unit 7.

The scorebook data read signal is input to the scorebook data processor 4. When the scorebook data read signal is input, the scorebook data processor 4 reads the scorebook data stored in the scorebook data storage unit 26 and outputs the read scorebook data to a target data identifying unit 10 and a result data extracting unit 11 of the scorebook data extracting unit 6 as a scorebook signal. In addition, a stop signal is input to the scorebook data processor 4. When the stop signal is input, the scorebook data processor 4 stops the reading and outputting of the scorebook data.

A video signal and a synchronization timing signal are input to the synchronization signal extracting unit 5. When the synchronization timing signal is input while the video signal is input, the synchronization signal extracting unit 5 reads the synchronization information stored in the synchronization information storage unit 27. The synchronization signal extracting unit 5 compares the read synchronization information with time data of the video data at a time point when the synchronization timing signal is input, extracts time of the video data, and extracts a tag corresponding to the extracted time from the tag data 55. The synchronization signal extracting unit 5 outputs the extracted time to the batting video extracting unit 7 as a time signal. In addition, the synchronization signal extracting unit 5 outputs the extracted tag to the scorebook data extracting unit 6 as a synchronization signal. When the stop signal is input, the synchronization signal extracting unit 5 stops the reading and outputting of the time signal and the synchronization signal.

The scorebook data extracting unit 6 includes a target data identifying unit 10 and a result data extracting unit 11. The scorebook signal and the synchronization signal are input to the target data identifying unit 10. The target data identifying unit 10, based on the scorebook signal and the synchronization signal that have been input, identifies a tag corresponding to the tag extracted from the synchronization signal extracting unit 5 from the tag data 43 of the scorebook data. The target data identifying unit 10 outputs the identified tag to the result data extracting unit 11 as a identified signal. When the input of the scorebook signal and the synchronization signal is stopped, the target data identifying unit 10 stops the output of the identified signal.

The scorebook signal and the identified signal are input to the result data extracting unit 11. The result data extracting unit 11 extracts a hitting result based on the scorebook signal and the identified signal that have been input. For example, the result data extracting unit 11 searches for an at-bat including the tag identified by the target data identifying unit 10 among the scorebook data from the at-bat record 45 and extracts pitching result information for a last pitch in the at-bat as a hitting result. In addition, the result data extracting unit 11 also extracts a pitching number which leads a hitting result, in other words, a pitching number of a pitch at which the hitting result is generated. The result data extracting unit 11 outputs the hitting result and the pitching number that have been extracted to the data superimposing unit 8 as a result signal. When the input of the scorebook signal and the identified signal is stopped, the result data extracting unit 11 stops the output of the result signal.

The video signal and the time signal are input to the batting video extracting unit 7. When only the video signal is input, the batting video extracting unit 7 outputs the input video signal to the data superimposing unit 8 as a batting video signal. On the other hand, when the video signal and the time signal are input, the batting video extracting unit 7, based on the video signal and the time signal that have been input, outputs video data of time corresponding to the tag extracted by the synchronization signal extracting unit 5 and video data of time after that to the data superimposing unit 8 as a batting video signal.

The batting video signal and the result signal are input to the data superimposing unit 8. The data superimposing unit 8, based on the batting video signal and the result signal that have been input, generates a display video signal. More specifically, the data superimposing unit 8 generates a display video signal such that the hitting result is superimposed with the game video to be displayed in the display 9. The data superimposing unit 8 outputs the generated display video signal to the display 9. When the input of the result signal is stopped, the data superimposing unit 8 stops the generation and the output of the display video signal and outputs only the display video signal to the display 9.

The video storage and processing unit 12, based on the display video signal output from the data superimposing unit 8 to the display 9, stores a game video 61 which is overlapped with result information 62 in the superimposed video storage unit 28. In addition, the video storage and processing unit 12, based on the display video signal output from the data superimposing unit 8 to the display 9, stores the game video 61 in the batting video storage unit 29.

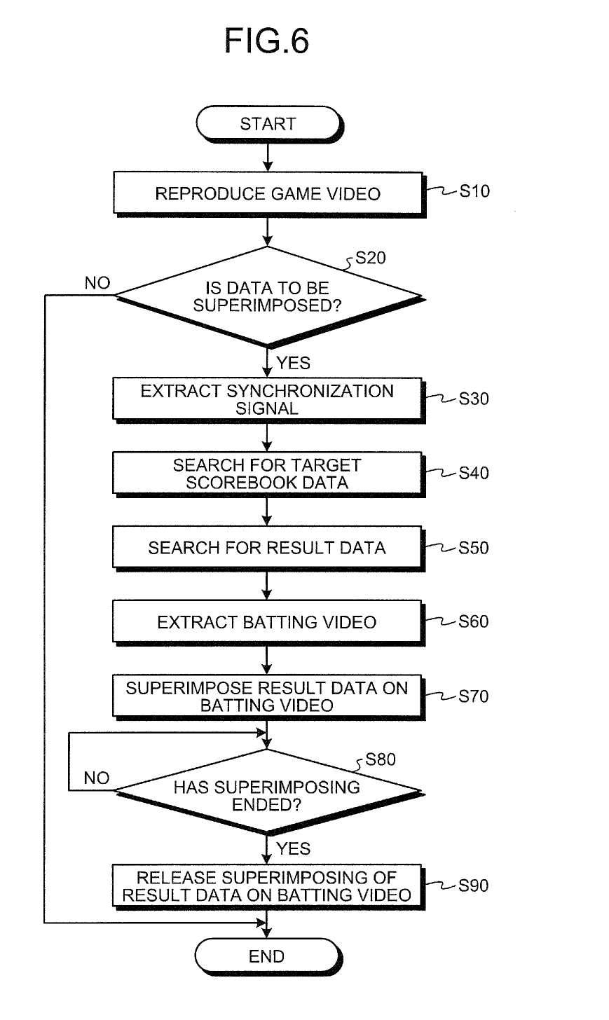

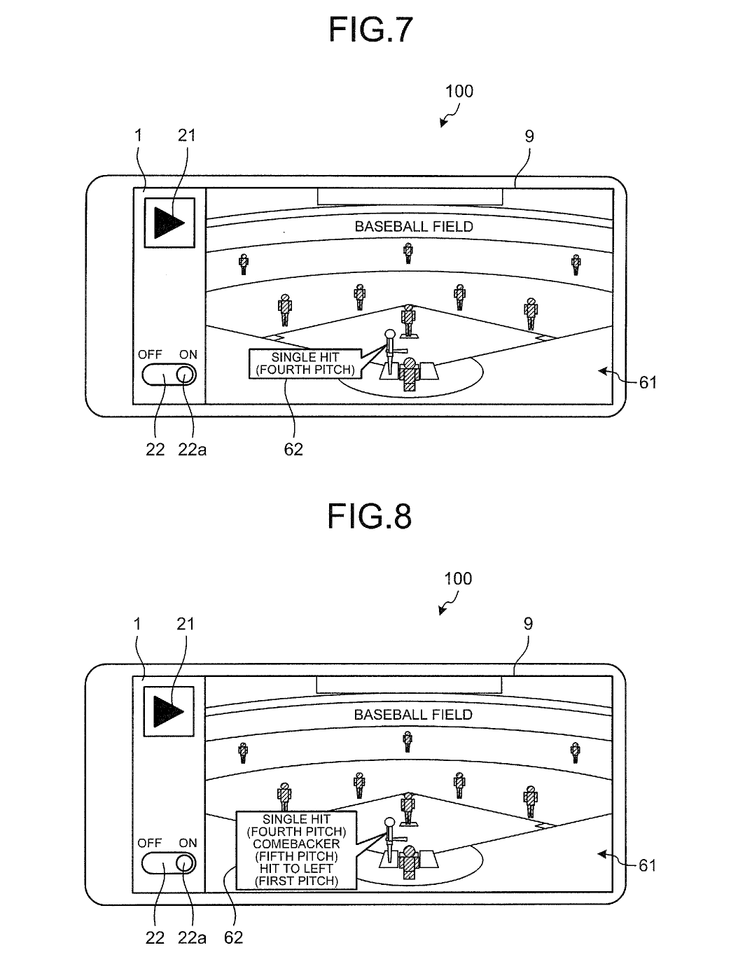

Next, operation of the display device 100 configured as described above will be described. FIG. 6 is a flowchart that illustrates an example of the operation of the display device 100 according to this embodiment. FIGS. 7 to 9 are diagrams that illustrate display contents of the display 9 of the display device 100.

As illustrated in FIG. 6, in the input unit 1, for example, when a touch operation is performed on the button 21, the input unit 1 outputs the first command signal to the input signal processor 2. The input signal processor 2 outputs the video data read signal to the video data processor 3. The video data processor 3 reads video data stored in the video data storage unit 25 and outputs the video signal to the synchronization signal extracting unit 5 and the batting video extracting unit 7. The batting video extracting unit 7 outputs the batting video signal to the data superimposing unit 8. The data superimposing unit 8 outputs the display video signal to the display 9. Accordingly, on the display 9, game video 61 (see FIG. 2) of a baseball is displayed based on the display video signal (Step S10).

In this state, the input signal processor 2 determines whether or not an operation of superimposing video data with the result data is performed, in other words, whether or not the second command signal is output from the input unit 1 (Step S20). When the second command signal is output (Yes in Step S20), the input signal processor 2 outputs a scorebook data read signal to the scorebook data processor 4 and outputs the synchronization timing signal to the synchronization signal extracting unit 5.

The synchronization signal extracting unit 5 reads the synchronization information stored in the synchronization information storage unit 27, extracts time of the video data at the time point when the synchronization timing signal is input and extracts a tag corresponding to the extracted time from the tag data 55. Then, the extracted time is output to the batting video extracting unit 7 as a time signal. In addition, the extracted tag is output to the scorebook data extracting unit 6 as a synchronization signal (Step S30). Hereinafter, a case will be described as an example in which a tag having a tag number of TA0016 is extracted from among the synchronization information illustrated in FIG. 4. In such a case, the synchronization signal extracting unit 5 extracts time (0:03:21) corresponding to the tag number TA0016 among the time data 56 illustrated in FIG. 4.

The scorebook data processor 4 reads the scorebook data stored in the scorebook data storage unit 26 and outputs a scorebook signal to the target data identifying unit 10 of the scorebook data extracting unit 6. The target data identifying unit 10, based on the scorebook signal and the synchronization signal that have been input, identifies tag data 43 corresponding to the extracted tag data 55 from the plurality of pieces of tag data 43 included in the scorebook data and outputs a identified signal to the result data extracting unit 11 (Step S40). In Step S40, among the tag data 43 included in the scorebook data illustrated in FIG. 3, tag data having a tag number of TA0016 is identified.

The result data extracting unit 11 extracts a hitting result based on the identified result and outputs the hitting result to the data superimposing unit 8 as a result signal (Step S50). In Step S50, the result data extracting unit 11 identifies an at-bat corresponding to the tag number TA0016 among the scorebook data illustrated in FIG. 3 from the at-bat record 45. In this case, the result data extracting unit 11 identifies an at-bat having the at-bat number of D005. Then, the result data extracting unit 11 extracts pitching result information for a last pitch in the at-bat having the at-bat record number of D005 as a hitting result. In this case, the result data extracting unit 11 extracts a single hit as the hitting result. In addition, the result data extracting unit 11 also extracts a pitching number of a case where the hitting result is generated. In this case, the result data extracting unit 11 extracts a fourth pitch as the pitching number.

The batting video extracting unit 7 extracts video data of time extracted by the synchronization signal extracting unit 5 and video data of time after that among the video data and outputs the extracted video data to the data superimposing unit 8 as a batting video signal (Step S60). In Step S60, the batting video extracting unit 7 extracts video data of time (0:03:21) corresponding to the tag number TA0016 and video data of time after that, and outputs the extracted video data to the data superimposing unit 8 as a batting video signal. The data superimposing unit 8 generates a display video signal based on the batting video signal and the result signal that have been input and outputs the display video signal to the display 9 (Step S70).

In this way, on the display 9, as illustrated in FIG. 7, the result information 62 of the hitting result is displayed with being superimposed on the game video 61. In the case illustrated in FIG. 7, it is displayed that the hitting result is a single hit as the result information 62, and the pitching number at the time of generation of the hitting result is a fourth pitch. Thus, a viewer can quickly check that the batter got a single hit at the fourth pitch without checking the game video 61 up to the fourth pitch for the batter. Here, the video storage and processing unit 12 may store the game video 61 on which the result information 62 is superimposed in the superimposed video storage unit 28 based on the display video signal output from the data superimposing unit 8 to the display 9.

In this state, the input signal processor 2 determines whether or not the output of the second command signal from the input unit 1 has been stopped, in other words, determines whether or not a command for ending the process of superimposing the result data on the video data is made (Step S80). When the output of the second command signal is stopped (Yes in Step S80), the input signal processor 2 stops the outputting of the scorebook data read signal and the outputting of the synchronization timing signal.

In this case, the batting video signal is input from the batting video extracting unit 7 to the data superimposing unit 8, but a result signal is not input from the scorebook data extracting unit 6 thereto. Accordingly, the data superimposing unit 8 generates a display video signal based on only the batting video signal and inputs the display video signal to the display 9. In this way, on the display 9, the display of the result information 62 is stopped to be displayed, and the game video 61 is continuously displayed. In this way, the superimposing of the result information 62 on the batting video is released in the display 9 (Step S90). According to Step S90, only the game video 61 is displayed on the display 9. Also for a case where the second command signal is not output in Step S20 (No in Step S20), similarly, only the game video 61 is reproduced in the display 9. Thereafter, when an operation for ending the reproduction of the game video in the display device 100 is performed, the process performed by the controller 15 ends.

In the description presented above, while a case has been illustrated as an example in which the result data extracting unit 11 searches for an at-bat including the tag identified by the target data identifying unit 10 from the at-bat record 45 among the scorebook data and extracts pitching result information for a last pitch in the at-bat as a hitting result, the extraction is not limited thereto. For example, the result data extracting unit 11 may be configured to search for a batter corresponding to the tag identified by the target data identifying unit 10 from the individual ID 49 among the scorebook data and extract hitting results of the batter for all the at-bat.

For example, the target data identifying unit 10 identifies a batter corresponding to a tag number TA0016 from the individual ID 49 among the scorebook data illustrated in FIG. 3. In this case, the result data extracting unit 11 identifies a batter whose individual ID is 005 and extracts a hitting result and a pitching number for each of a plurality of at-bats of the batter 005. For example, the batter 005 hit a fifth pitched ball in the second at-bat to be a comebacker and hit a first pitched ball in the third at-bat to left. In this case, as illustrated in FIG. 8, on the display 9, hitting results and pitching numbers of the batter 005 for all the at-bats from the first at-bat to the third at-bat are displayed as the result information 62.

For example, the result data extracting unit 11 may extract a hitting result in an at-bat of a batter and a pitching number, and also extract a base running result of a runner in the at-bat. As the base running result, events specific to a runner, for example, a steal, a pick-off, and the like may be extracted, or events such as an advancement or left-on-base may be extracted. Hereinafter, a case will be described as an example in which the result data extracting unit 11 extracts a steal or a pick-off. In such a case, the result data extracting unit 11 searches for an at-bat corresponding to a tag identified by the target data identifying unit 10 from the at-bat records 45, and a steal or a pick-off is extracted from the runner score information 42 in the at-bat as a base running result.

For example, the target data identifying unit 10 is assumed to identify a batter corresponding to a tag number TA0028 from an individual ID 49 among the scorebook data illustrated in FIG. 3. In this case, the result data extracting unit 11 searches for an at-bat having an at-bat record number of D011 as an at-bat corresponding to the tag number TA0028 and extracts that a hitting result in the at-bat is pop out to right, and the pitching number represents a fifth pitch.

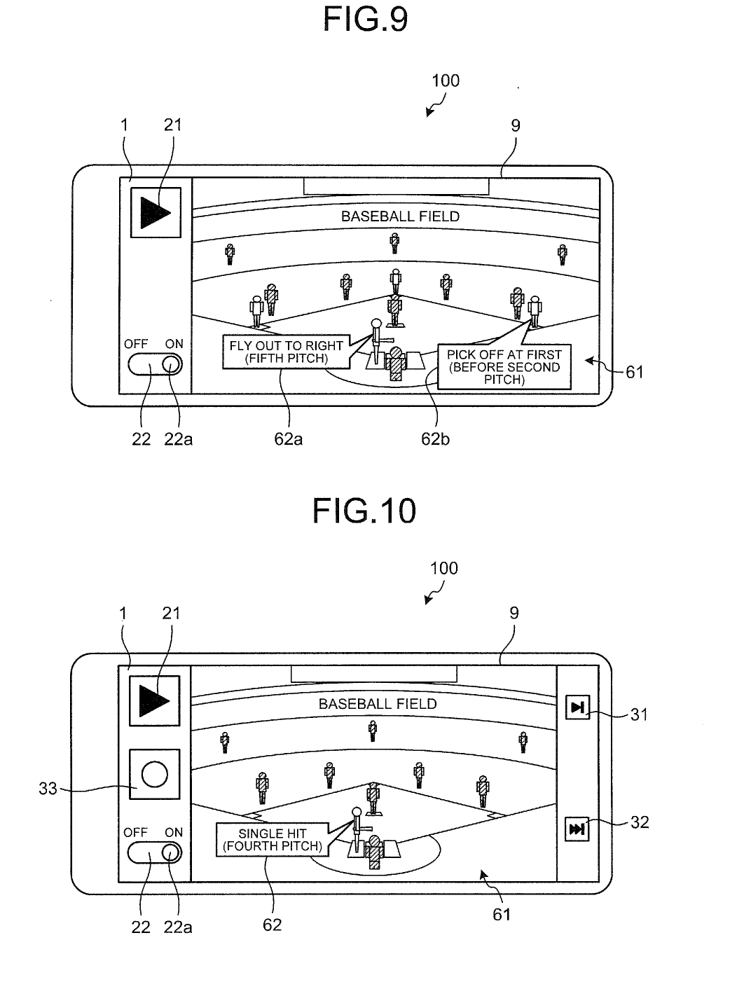

In addition, the result data extracting unit 11 searches for an at-bat corresponding to the at-bat record number of D011 and extracts a steal or a pick-off from the runner score information 42 for the at-bat as a base running result. The result data extracting unit 11 extracts that a first-base runner of an individual ID 001, after a first pitch, is out by a pick-off throw before a second pitch to the batter as the base running information. In this case, as illustrated in FIG. 9, on the display 9, together with result information 62a for a hitting result (pop out to right for a fifth pitch) of the batter 002, result information 62b for the pick-off on first base of the runner 001 appears. In addition, a pitching number of a case where the pick-off out may be displayed together as the result information 62b.

As described above, the display device 100 according to the first embodiment displays the game video 61 on the display 9 based on the video data of the games of baseball captured in advance when the first command signal is output from the input unit 1 and, when the second command signal is output from the input unit 1, extracts at least result data of a hitting result in an at-bat of a batter displayed on the display 9 from the scorebook data for the games and displays the result information 62 of the hitting result on the display 9 to be superimposed on the game video 61 based on the result data. Thus, with the display device 100, a viewer can quickly check the hitting result of a batter when the batter is displayed without reproducing the game video 61 until the hitting result of the batter appears. Accordingly, a viewer can effectively select and display a scene desired to be viewed among the game video of baseball. In this way, the display device 100 can display score information for game video of baseball more effectively.

### Second Embodiment

Next, a second embodiment will be described. A display device 100 according to the second embodiment has a configuration similar to that of the first embodiment. In the second embodiment, the same reference numeral is assigned to the same constituent element of the display device 100 according to the first embodiment, and description thereof will be omitted or simplified.

FIG. 10 is a diagram that illustrates a display content of a display 9 of a display device 100 according to the second embodiment. As illustrated in FIG. 10, on the display 9, for example, in addition to a button 21 and a switch 22, buttons 31, 32, and 33 are displayed as operation images. The buttons 31, 32, and 33 are displayed in mutually-different areas of the display 9.

When a touch operation is performed on an area of the touch panel on which the button 31, 32, or 33 is superimposed, an input unit 1 outputs a predetermined command signal. For example, when a touch operation is performed on an area on which the button 31 is superimposed as a fourth operation, the input unit 1 outputs a fourth command signal. Similarly, when a touch operation is performed on an area on which the button 32 is superimposed as a fifth operation, the input unit 1 outputs a fifth command signal. The fourth command signal and the fifth command signal will be described later. The configuration of the input unit 1 and the display 9 is not limited to the configuration described above.

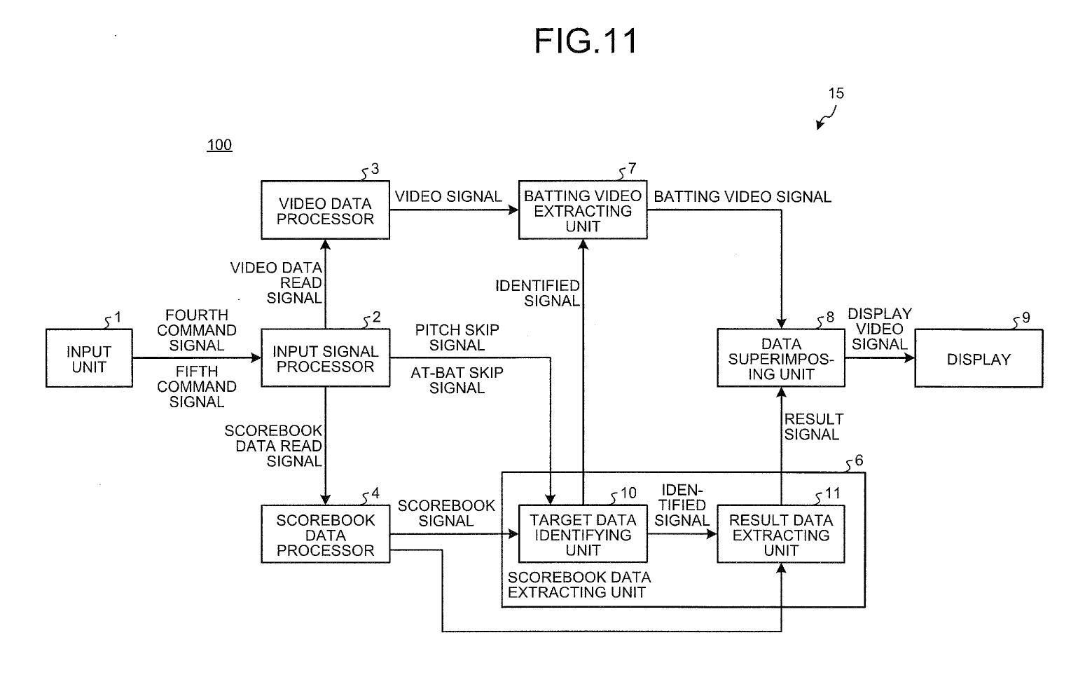

FIG. 11 is a block diagram that illustrates an example of a controller 15 of the display device 100 according to the second embodiment. As illustrated in FIG. 11, in addition to a first command signal, a second command signal, and a third command signal output from the input unit 1, a fourth command signal and a fifth command signal are input to an input signal processor 2.

When the fourth command signal is input, the input signal processor 2 outputs an at-bat skip signal to a target data identifying unit 10. When the fifth command signal is input, the input signal processor 2 outputs a pitch skip signal to the target data identifying unit 10. The at-bat skip signal and the pitch skip signal are control signals for controlling the target data identifying unit 10.

A video data read signal is input to a video data processor 3. When the video data read signal is input, the video data processor 3 reads video data stored in a video data storage unit 25 and outputs a video signal to a batting video extracting unit 7.

A scorebook data read signal is input to a scorebook data processor 4. When the scorebook data read signal is input, the scorebook data processor 4 reads scorebook data stored in a scorebook data storage unit 26 and outputs the read scorebook data to a target data identifying unit 10 and a result data extracting unit 11 of a scorebook data extracting unit 6 as a scorebook signal.

The scorebook data extracting unit 6 includes a target data identifying unit 10 and a result data extracting unit 11. The scorebook signal, the at-bat skip signal, and the pitch skip signal are input to the target data identifying unit 10. When the scorebook signal and the at-bat skip signal are input, the target data identifying unit 10 identifies a tag of a first pitch in an at-bat which is different from the at-bat corresponding to a time point at which the at-bat skip signal is input from the tag data 43 of the scorebook data. The target data identifying unit 10, for example, may identify a tag of a first pitch of the next at-bat of the at-bat corresponding to the time point at which the at-bat skip signal is input from the tag data 43 of the scorebook data.

Similarly, when the scorebook signal and the pitch skip signal are input, the target data identifying unit 10 identifies a tag of a pitch corresponding to a pitching record number which is different from the pitching record number corresponding to a time point at which the pitch skip signal is input from the tag data 43 of the scorebook data. The target data identifying unit 10, for example, may identify a tag of the next pitch of the pitch corresponding to the time point at which the pitch skip signal is input from the tag data 43 of the scorebook data.

The target data identifying unit 10 outputs the input scorebook signal to the result data extracting unit 11 and outputs the identified tag to the result data extracting unit 11 and the batting video extracting unit 7 as a identified signal.

The scorebook signal and the identified signal are input to the result data extracting unit 11. The result data extracting unit 11, for example, extracts a hitting result and a pitching number based on the scorebook signal and the identified signal that have been input. The result data extracting unit 11 outputs the hitting result and the pitching number that have been extracted to a data superimposing unit 8 as a result signal.

The video signal and the identified signal are input to the batting video extracting unit 7. When the identified signal is input, the batting video extracting unit 7, based on the video signal and the identified signal that have been input, extracts video data of time corresponding to the tag identified by the target data identifying unit 10 and video data of time after that among the video data and outputs the extracted video data to the data superimposing unit 8 as a batting video signal.

The batting video signal and the result signal are input to the data superimposing unit 8. The data superimposing unit 8, based on the batting video signal and the result signal that have been input, generates a display video signal. The data superimposing unit 8 outputs the generated display video signal to the display 9.

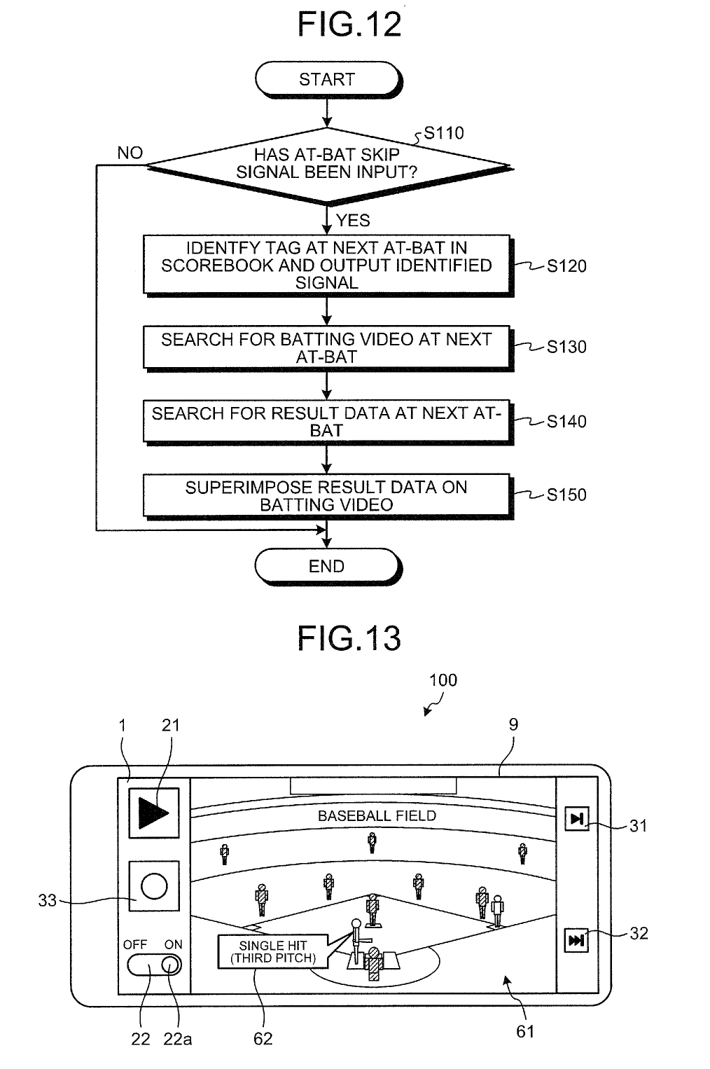

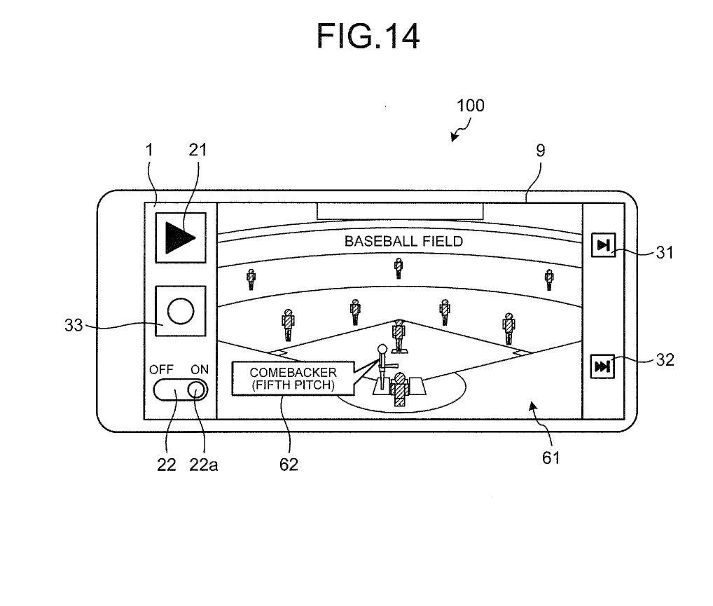

Next, the operation of the display device 100 according to the second embodiment will be described. FIG. 12 is a flowchart that illustrates an example of the operation of the display device 100 according to this embodiment. FIGS. 13 and 14 are diagrams that illustrate display contents of the display 9 of the display device 100. In the case illustrated in FIG. 12, a case will be described as an example in which the fourth command signal is output after the first command signal and the second command signal are output. In this case, for example, as illustrated in FIG. 10, on the display 9, game video 61 and result information 62 are displayed. Hereinafter, for example, a case will be described as an example in which a scene, on which a batter of an individual ID 005 illustrated in FIG. 3 comes to bat of an at-bat number D005, is displayed. In this case, as the result information 62, score information corresponding to the pitching result information of a pitching record number A008, in other words, a single hit at a fourth pitch is illustrated.

As illustrated in FIG. 12, the input signal processor 2 determines whether or not the fourth command signal is output from the input unit 1, in other words, it is determined whether or not an at-bat skip command is performed (Step S110). When the fourth command signal is output (Yes in Step S110), the input signal processor 2 outputs the scorebook data read signal to the scorebook data processor 4 and outputs the at-bat skip signal to the target data identifying unit 10. When the fourth command signal is not output (No in Step S110), the process ends without performing the following process.

The scorebook data processor 4 reads the scorebook data stored in the scorebook data storage unit 26 and outputs a scorebook signal to the target data identifying unit 10 of the scorebook data extracting unit 6. The target data identifying unit 10, based on the scorebook signal and the at-bat skip signal that have been input, identifies a tag of a first pitch of the next at-bat of the at-bat corresponding to a time point at which the at-bat skip n signal is input from the tag data 43 of the scorebook data and outputs a identified signal to the batting video extracting unit 7 and the result data extracting unit 11 (Step S120). In Step S120, among the tag data 43 of the scorebook data illustrated in FIG. 3, a tag corresponding to a first pitch in an at-bat having an at-bat record number of D006, in other words, a tag having a tag number TA0019 is identified.

The batting video extracting unit 7 outputs video data of time corresponding to the tag having the tag number TA0019 and video data of time after that to the data superimposing unit 8 as a batting video signal (Step S130). In Step S130, the batting video extracting unit 7 outputs video data of time (0:05:12) corresponding to the tag number TA0019 and video data of time after that among the time data 56 illustrated in FIG. 4 to the data superimposing unit 8 as a batting video signal.

The result data extracting unit 11 extracts result data of a hitting result based on the identified signal and outputs the result data to the data superimposing unit 8 (Step S140). In Step S140, the result data extracting unit 11 extracts pitching result information for a last pitch in the at-bat having an at-bat record number of D006 among the scorebook data illustrated in FIG. 3 as a hitting result. In this case, the result data extracting unit 11 extracts a single hit as the hitting result. In addition, the result data extracting unit 11 also extracts a pitching number of a case where the hitting result is generated. In this case, the result data extracting unit 11 extracts a third pitch as the pitching number.

The data superimposing unit 8 generates a display video signal based on the video signal and the result signal that have been input and outputs the display video signal to the display 9 (Step S150). In this way, on the display 9, as illustrated in FIG. 13, the result information 62 of the pitching result is superimposed on the game video 61 to be displayed. This game video 61 is video of a case where a batter having an individual ID 006 illustrated in FIG. 3 comes to bat of an at-bat record number D006. A player of an individual ID 005 illustrated in FIG. 10 becomes a first-base runner in accordance with a single hit in FIG. 13. In addition, as the result information 62, an hitting result of the at-bat record number D006 is illustrated (a single hit at the third pitch).

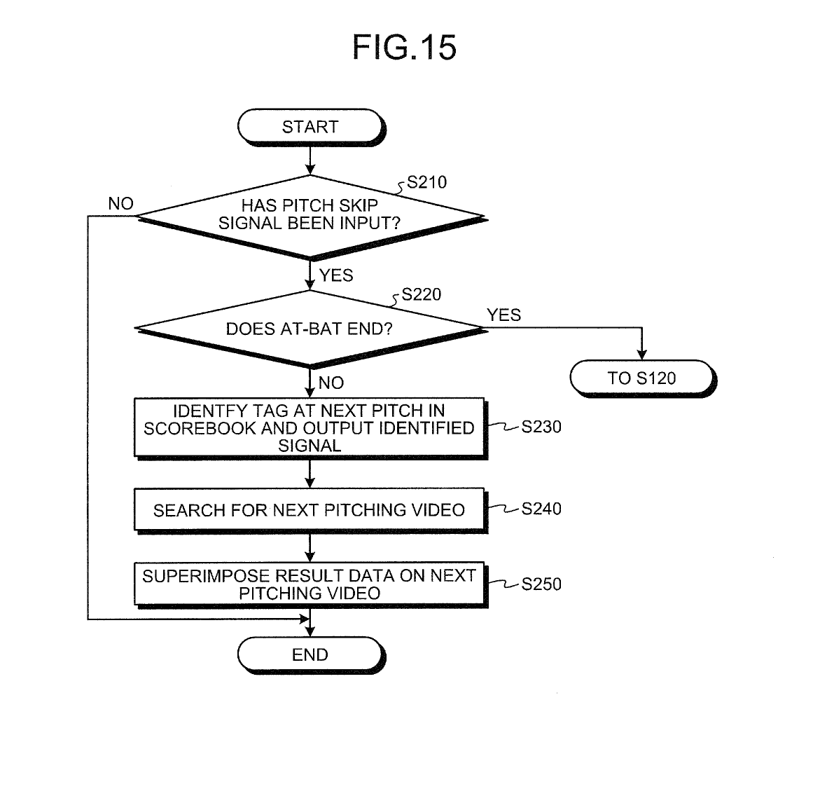

FIG. 15 is a flowchart that illustrates another example of the operation of the display device 100 according to this embodiment. In the case illustrated in FIG. 15, a case will be described as an example in which the fifth command signal is output under a state in which the first command signal and the second command signal are output. Similar to the case where the fourth command signal is output, for example, a case will be described as an example in which a scene, on which the batter of the individual ID 005 illustrated in FIG. 3 comes to bat of the at-bat record number D005, is displayed.

As illustrated in FIG. 15, the input signal processor 2 determines whether or not the fifth command signal is output from the input unit 1, in other words, it is determined whether or not the pitch skip command is performed (Step S210). When the fifth command signal is output (Yes in Step S210), the input signal processor 2 determines whether or not the at-bat ends according to a pitch performed at a time point at which the fifth command signal is output (Step S220). When the fifth command signal is not output (No in Step S210), the process ends without performing the following process.

When the at-bat is determined to end according to the pitch performed at the time point at which the fifth command signal is output (Yes in Step S220), the input signal processor 2 performs the process of Step S120 and subsequent steps. On the other hand, when the at-bat is determined not to end according to the pitch performed at the time point at which the fifth command signal is output (No in Step S220), the input signal processor 2 outputs a scorebook data read signal to the scorebook data processor 4 and outputs the pitch skip signal to the target data identifying unit 10.

The scorebook data processor 4 reads the scorebook data stored in the scorebook data storage unit 26 and outputs a scorebook signal to the target data identifying unit 10 of the scorebook data extracting unit 6. The target data identifying unit 10, based on the scorebook signal and the pitch skip signal that have been input, identifies a tag of the next pitch of the pitch performed at the time point at which the pitch skip signal is input from the tag data 43 of the scorebook data and outputs a identified signal to the batting video extracting unit 7 and the result data extracting unit 11 (Step S230). In Step S230, among the tag data 43 of the scorebook data illustrated in FIG. 3, a tag corresponding to a third pitch in an at-bat having an at-bat record number of D005, in other words, a tag having a tag number TA0017 is identified.

The batting video extracting unit 7 outputs video data of time corresponding to the tag having the tag number TA0017 and video data of time after that to the data superimposing unit 8 as a batting video signal (Step S240). In Step S240, the batting video extracting unit 7 outputs video data of time (0:03:55) corresponding to the tag number TA0017 and video data of time after that among the time data 56 illustrated in FIG. 4 to the data superimposing unit 8 as a batting video signal. The result data extracting unit 11 extracts result data of a hitting result based on the identified result and outputs the result data to the data superimposing unit 8. The result data extracting unit 11 extracts pitching result information for a last pitch in the at-bat corresponding to the at-bat record number of D005 among the scorebook data illustrated in FIG. 3 as a hitting result. Accordingly, the result data extracting unit 11 extracts the same hitting result as that of the case illustrated in FIG. 10.

The data superimposing unit 8 generates a display video signal based on the video signal and the result signal that have been input and outputs the display video signal to the display 9 (Step S250). In this way, on the display 9, the game video 61 of the the third pitch and the result information 62 which shows a single hit at the fourth pitch are displayed.

In the description presented above, in the target data identifying unit 10, an operation, when the at-bat skip signal is input, of identifying a tag at a first pitch of the next at-bat of the at-bat corresponding to the time point at which the at-bat skip signal is input from the tag data 43 of the scorebook data has been described, the operation is not limited thereto. For example, the target data identifying unit 10 may identify a tag at a first pitch in the next at-bat of the same batter as the batter corresponding to the time point at which the at-bat skip signal is input from the tag data 43 of the scorebook data. In such a case, as illustrated in FIG. 14, on the display 9, a hitting result of the second at-bat of the batter having the individual ID 005 and a pitching number (a comebacker at the fifth pitch) can be displayed as the result information 62.

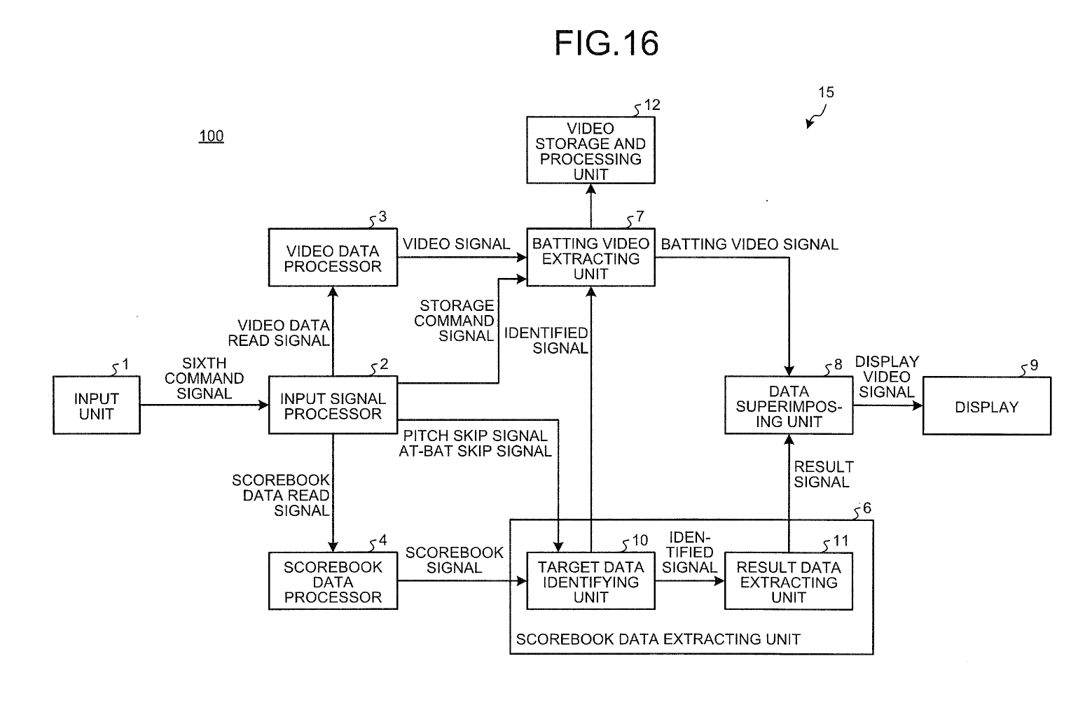

In addition, in the description presented above, the input unit 1 may be configured to output a sixth command signal when a touch operation is performed on an area on which the button 33 is superimposed as a sixth operation. FIG. 16 is a block diagram that illustrates another example of the controller 15 of the display device 100 according to the second embodiment. As illustrated in FIG. 16, the input signal processor 2 may output a storage command signal to the batting video extracting unit 7 when the sixth command signal is input.

The storage command signal is input to the batting video extracting unit 7. When the storage command signal is input, the batting video extracting unit 7 outputs a video signal output to the data superimposing unit 8 to the video storage and processing unit 12. A video signal is input from the batting video extracting unit 7 to the video storage and processing unit 12. When the video signal is input, the video storage and processing unit 12 stores the video data in the batting video storage unit 29.

According to such a configuration, a viewer can perform a touch operation for the button 33 in a state in which the result information of the at-bat is superimposed on the batting video signal to be displayed. Thus, the viewer can operate the buttons 31 and 32 while checking the result information, and, when a scene desired to be stored is displayed, the displayed video can be easily stored by operating the button 33.

According to the present disclosure, a display device, a display method, and a non-transitory storage medium which stores a display program capable of more effectively displaying score information for game video of a baseball game can be provided.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display device comprising:
a display configured to be capable of displaying information including video;
an input unit configured to be capable of outputting a first command signal when a first operation is performed and outputting a second command signal when a second operation is performed;
a storage configured to store video data of a game of baseball captured in advance and scorebook data for the game; and
a controller configured to, when the first command signal is output, display game video of the game on the display based on the video data, and, when the second command signal is output, extract a hitting result in at least at-bat of a batter displayed on the display from the scorebook data and display the game video of the game on the display while superimposing result information including the hitting result on the game video.

2. The display device according to claim 1, wherein the input unit is further configured to be capable of outputting a third command signal when a third operation is performed, and when the third command signal is output while the game video and the result information are displayed on the display, the controller is further configured to stop the display of the result information and display the game video continuously.

3. The display device according to claim 1, wherein the result information includes information relating to a pitching number of a case in which the hitting result is generated in the at-bat.

4. The display device according to claim 1, wherein the input unit is further configured to be capable of outputting a fourth command signal when a fourth operation is performed, and when the fourth command signal is output, the controller is further configured to switch a scene of the game video displayed on the display for each at-bat to display the scene on the display, and display the game video of the game on the display while superimposing result information in at-bat in the switched scene on the game video after switching the scene.

5. The display device according to claim 1, wherein the input unit is further configured to be capable of outputting a fifth command signal when a fifth operation is performed, and when the fifth command signal is output, the controller is further configured to switch a scene of the game video displayed on the display for each pitch of a pitcher to display the scene on the display, and display the game video of the game on the display while superimposing result information in at-bat corresponding to a pitch in the switched scene on the game video after switching the scene.

6. The display device according to claim 1, wherein
the input unit is further configured to include a touch panel disposed on the display,
the controller is further configured to display an operation image on the display, and
when a touch operation is performed on an area in the touch panel on which the operation image is superimposed, the input unit is further configured to output a predetermined signal to the controller.

7. The display device according to claim 1, wherein the storage is further configured to store synchronization information which associates the video data with the scorebook data.

8. The display device according to claim 7, wherein the controller is further configured to store at least one of the game video with the result information being superimposed and the game video without the result information being superimposed in the storage.

9. The display device according to claim 1, wherein the controller is further configured to extract a base running result of a runner in at-bat of a batter displayed on the display and display the game video of the game on the display while superimposing the base running result as the result information on the game video.

10. A display method for displaying information in a display device including
a display configured to be capable of displaying information including video,
an input unit configured to be capable of outputting a first command signal when a first operation is performed and outputting a second command signal when a second operation is performed, and
a storage configured to store video data of a game of baseball captured in advance and scorebook data for the game, the display method comprising:
displaying game video of the game on the display based on the video data when the first command signal is output; and
extracting a hitting result in at least at-bat of a batter displayed on the display from the scorebook data and displaying the game video of the game on the display while superimposing result information including the hitting result on the game video when the second command signal is output.

11. A non-transitory storage medium that stores a display program for displaying information in a display device including
a display configured to be capable of displaying information including video,
an input unit configured to be capable of outputting a first command signal when a first operation is performed and outputting a second command signal when a second operation is performed, and
a storage configured to store video data of a game of baseball captured in advance and scorebook data for the game, the display program causing the display device to perform processes of:
displaying game video of the game on the display based on the video data when the first command signal is output; and
extracting a hitting result in at least at-bat of a batter displayed on the display from the scorebook data and displaying the game video of the game on the display while superimposing result information including the hitting result on the game video when the second command signal is output.
